(19) United States
(12) Patent Application Publication
(10) Pub. No.: US 2009/0092299 A1
(43) Pub. Date: Apr. 9, 2009

(54) System and Method for Joint Classification Using Feature Space Cluster Labels

(75) Inventors: Anna Jerebko, West Chester, PA (US); Shipeng Yu, Exton, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/241,178

(22) Filed: Sep. 30, 2008

Related U.S. Application Data
(60) Provisional application No. 60/977,103, filed on Oct. 3, 2007.

(51) Int. Cl. G06K 9/00; G06K 9/62

(52) U.S. Cl. 382/128; 382/225

(57) ABSTRACT

A method for training a classifier for use in a computer aided detection system includes providing a training set of images acquired from a plurality of patients, each said image including one or more candidate regions that have been identified as suspicious by a candidate generation step of a computer aided detection system, and wherein each said image has been manually annotated to identify lesions, using said training set to train a classifier adapted for identifying a candidate region as a lesion or non-lesion, clustering candidate regions having similar features for each patient individually, and modifying said trained classifier decision boundary with an additional classification step incorporating said individual candidate region clustering.

### CROSS REFERENCE TO RELATED UNITED STATES APPLICATIONS

This application claims priority from “Joint Classification Using Feature Space Cluster Label”, U.S. Provisional Application No. 60/977,103 of Anna Jerebko, filed Oct. 3, 2007, the contents of which are herein incorporated by reference in their entirety.

### TECHNICAL FIELD

This disclosure is directed to improving the specificity of computer aided algorithms for lesion detection, such as colon polyp detection, lung nodule detection, lymph node detection, etc.

### DISCUSSION OF THE RELATED ART

In computer aided detection (CAD), certain types of pathological findings are likely to occur multiple times in the same patient. The following examples of lung pathologies could negatively affect the specificity of an automatic lung nodule detection algorithm: asbestos plagues, bronchiolitis, retractile fibrosis, patchy ground glass opacification, etc. In colon polyp detection applications, polyposis or diverticulitis disease can also negatively affect the accuracy of the algorithm.

On the other hand, automatic lesion detection algorithms are often mislead by multiple false positive detections (artifacts) or benign findings occurring in the same patient, such as stool balls littering colon wall, streak artifacts, scarring, atelectesis, small airway disease in lungs. Some of these findings in the same patient could easily be dismissible for a computer algorithm, while others of the same nature may look more like a pathology that the algorithm is trying to detect, if the algorithm does not take into account multiple occurrences of similar findings. For example, in computed tomography (CT) images of the lungs, the same finding, such as a calcified bump attached the lung wall, would count as a nodule or a potentially malignant detection if it is found by itself, or, in other words, if there is only an isolated instance of such detection. On the other hand, if there are multiple similar calcified bumps attached to the lung wall, then they are most likely to be asbestos plagues.

Human readers can take onto account all findings in the same patient when they a make a decision on each particular finding.

Most of state of art computer aided detection algorithms are based on an assumption that all the candidates in one case are independent during training and testing. So in training, such algorithms treat them as individual samples, and in testing, classify each candidate individually, except for post-processing merges to reduce the number of false positives. Since some candidate detections from the same patient are strongly correlated, e.g. have similar shapes, occur in similar locations, etc, these correlations should be taken into account in a computer aided detection algorithm. This is how the human readers make a decision about the nature of the detections, which could be real lesions or false positive detections.

### SUMMARY OF THE INVENTION

Exemplary embodiments of the invention as described herein generally include methods and systems for improving CAD classification by using local analysis within one patient case and global analysis across patients. A method according to an embodiment of the invention clusters in a feature space all candidate findings in a same patient, then classifies each cluster jointly. Alternatively, the detections could be classified individually, but classification priors could be derived from cluster membership.

For example, if there are many stool balls in a patient's colon, some of them may look like polyps. A goal of the clustering algorithm according to an embodiment of the invention is to determine whether they look similar to other more oddly shaped stool balls that could be more easily distinguished from the true polyp findings. Similarly, in the lungs, a particular scar may be a border-line round shape that could be mistaken for a nodule. If the scar is correctly clustered with all the other scar tissue in the same patient, then a joint classification algorithm according to an embodiment of the invention can more likely make a correct decision than a conventional algorithm that looks at each finding separately.

According to an aspect of the invention, there is provided a method for training a classifier for use in a computer aided detection system, the method including providing a training set of images acquired from a plurality of patients, each said image including one or more candidate regions that have been identified as suspicious by a candidate generation step of a computer aided detection system, and wherein each said image has been manually annotated to identify lesions, using said training set to train a classifier adapted for identifying a candidate region as a lesion or non-lesion, clustering candidate regions having similar features for each patient individually, and modifying said trained classifier decision boundary with an additional classification step incorporating said individual candidate region clustering.

According to a further aspect of the invention, using said training set to train a classifier comprises deriving a set of multidimensional descriptive feature vectors from a feature computation step of a computer aided diagnosis system, wherein each candidate region is associated with a feature vector, and using the descriptive feature vectors from the training set of images to train said classifier to identify whether or not a candidate region is a lesion.

According to a further aspect of the invention, clustering candidate regions having similar features for each patient individually comprises selecting a subset of said descriptive feature vectors suitable for clustering and applying a clustering algorithm to the subset of features to cluster the candidate regions for each patient separately.

According to a further aspect of the invention, the method includes assigning a label assigned to a majority of cluster members to all members of said cluster.

According to a further aspect of the invention, the method includes providing a providing a testing set of images acquired from a plurality of patients different from said training set, and applying said clustering algorithm to individual patient images in the testing set.

According to a further aspect of the invention, the classifier is trained on a subset of said features in each feature vector.

According to a further aspect of the invention, clustering candidate regions having similar features for each patient individually comprises identifying and labeling those descriptive features having a highest probability of being associated with either a true-positive output of said classifier or a false-positive output of said classifier, and propagating the labels of the most probable true-positive candidate detections and most probable false-positive candidate detection.

According to a further aspect of the invention, the label propagation is performed using an adjacency graph approach.

According to another aspect of the invention, there is provided a program storage device readable by a computer, tangibly embodying a program of instructions executable by the computer to perform the method steps for training a classifier for use in a computer aided detection system.

### BRIEF DESCRIPTION OF THE DRAWINGS

FIG. 1 illustrates a case where candidates are well separated by the learned classifier, according to an embodiment of the invention.

FIG. 2 illustrates a case where the candidates form Gaussian clusters, according to an embodiment of the invention.

FIG. 3 illustrates a case where the candidates form non-Gaussian clusters, according to an embodiment of the invention.

FIG. 4 is a flowchart of a method for joint classification using feature space cluster labels, according to an embodiment of the invention.

FIG. 5 is a flowchart of another method for joint classification using feature space cluster labels, according to an embodiment of the invention.

FIG. 6 is a block diagram of an exemplary computer system for implementing a method for joint classification using feature space cluster labels, according to an embodiment of the invention.

### DETAILED DESCRIPTION OF EXEMPLARY EMBODIMENTS

Exemplary embodiments of the invention as described herein generally include systems and methods for joint classification using feature space cluster labels. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

As used herein, the term “image” refers to multi-dimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R, the methods of the inventions are not limited to such images, and can be applied to images of any dimension, e.g., a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

An algorithm according to an embodiment of the invention can improve CAD classification by using local analysis (e.g. within one patient case) and global analysis (e.g. common trends across patients). There are substructures or subcategories of the objects of interest or potential detections, both within the images of one patient and across different patients. An algorithm according to an embodiment of the invention uses this knowledge in the CAD applications.

Given a reasonably good classifier, trained on all patients in a training set without taking into account the clustering information, one can modify the classifier in the testing phase to boost performance. This modification of the testing phase is referred to herein below as Locality Preserved Testing, or Personalized Testing.

A simple example, illustrated in FIGS. 1-3, can clarify this idea. Suppose there is a classifier trained in a 2D feature space, where the dotted line 11 in the figures represents the classifier, the coordinate axes of the features, and there are 3 test cases where the black dots 12 and circles 13 are candidates. More specifically, the dots represent descriptive feature vectors associated with each candidate. Typically, a candidate is the result of a candidate detection step of a computer aided detection (CAD) algorithm, while the feature vector is calculated for each candidate by a feature computation step of a CAD algorithm. An exemplary feature vector can have up to several hundred components. These figure elements are only labeled for FIG. 1, to avoid cluttering the figures. In each of these three figures, circles represent true-positive lesions, and black dots represent non-lesion or false positive detections. It is desired to apply the classifier to each of these three cases and classify each candidate as the object of interest (e.g. nodule, polyp or other lesion) or otherwise label it as a false detection.

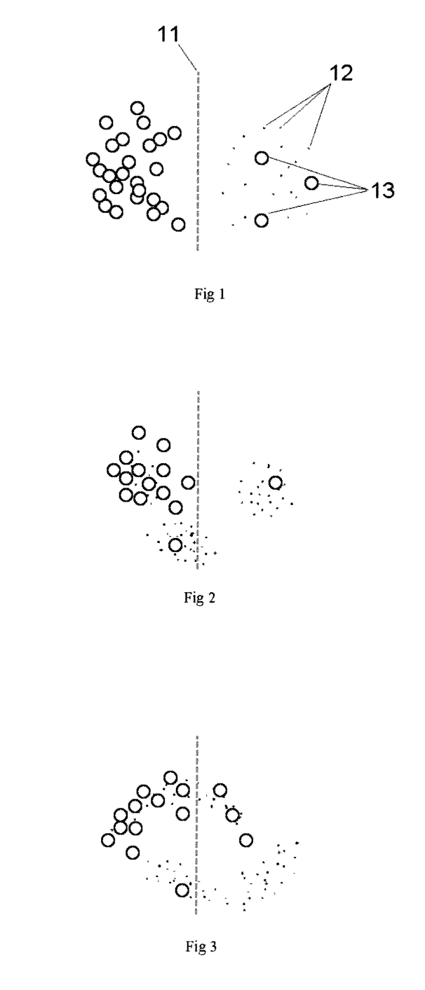

The learned classifier would appear to be suitable for the situation of FIG. 1, because the candidates are well separated by the learned classifier, except for a few outliers, which is normal in most classification tasks. But this classifier might not be optimal for the situations depicted in FIGS. 2 and 3. The clusters in which majority of detections are labeled as false positives, should in fact be entirely classified as false positive. Although the true labels of these candidates is unknown, one might guess that if there is a cluster of the candidates in each of the cases, the labels for all the points in the one cluster should be the same, i.e. a majority-win situation. For example, in FIG. 2, there are approximately 3 clusters, where the cluster dots are Gaussian distributed in the feature space about a cluster center, and the bottom cluster is split by the classifier. A more suitable solution would be to only assign one classification label to the whole cluster, which means assigning the label by majority voting in this cluster. In FIG. 3, there are 2 non-Gaussian-shaped clusters, i.e. the points are not Gaussian distributed about a center point, and an optimal classification for this case would separate the two moon-shape point clouds as two different labels. So the idea is, even with an independently-trained classifier, to adapt a classifier to each test case. A slightly adapted classifier for each of these cases might provide better performance over all.

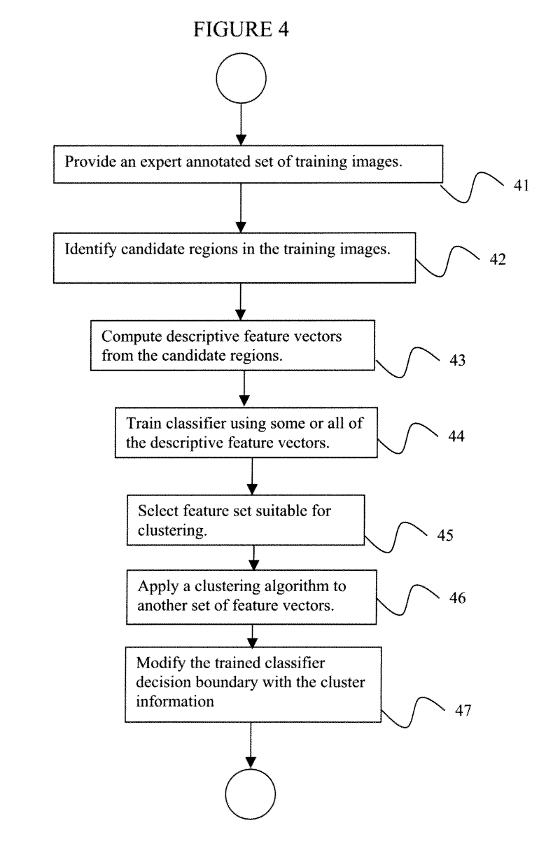

FIG. 4 is a flowchart of a method for joint classification using feature space cluster labels, according to an embodiment of the invention. An algorithm according to an embodiment of the invention starts by providing at step 41 an expert annotated set of training images of an organ, and, at step 42, identifying candidate regions in the training images. At step 43, a multidimensional feature vector is computed for each candidate region. This feature vector is used at step 44 to train a classifier to classify the candidate regions in the organ as lesions or non-lesions. All of the training images are used for this step, ignoring the clustering effect within each case. However, not all of the feature vectors need be used, and even if all feature vectors are used, not all components features need be used for the classifier training. Any suitable classification method can be used, such as such as a support vector machine, linear or quadratic discriminate analysis, etc. Next, at step 45, a set of features F2 suitable for clustering are selected using any of the commonly used feature selection algorithms, such as greedy search, principal component analysis, wrapper and filter methods, and at step 46 a clustering algorithm is applied for the candidates within each image. The feature set F2 selected for clustering could be different from the feature set used for classification. While classifier is trained on the whole training set of multiple patients, a clustering algorithm is applied to each patient separately, so the feature sets selected in two steps could be different. The output of the clustering algorithm a unique label (i.e. a cluster id) for each candidate. At step 47, the trained classifier is modified with the cluster information. An approach according to an embodiment of the invention is a winner-take-all for each cluster, where a label assigned to a majority of the cluster members will be assigned to all cluster members. This modification represents an addition step to the classification, rather than a modification to the feature vector weights themselves.

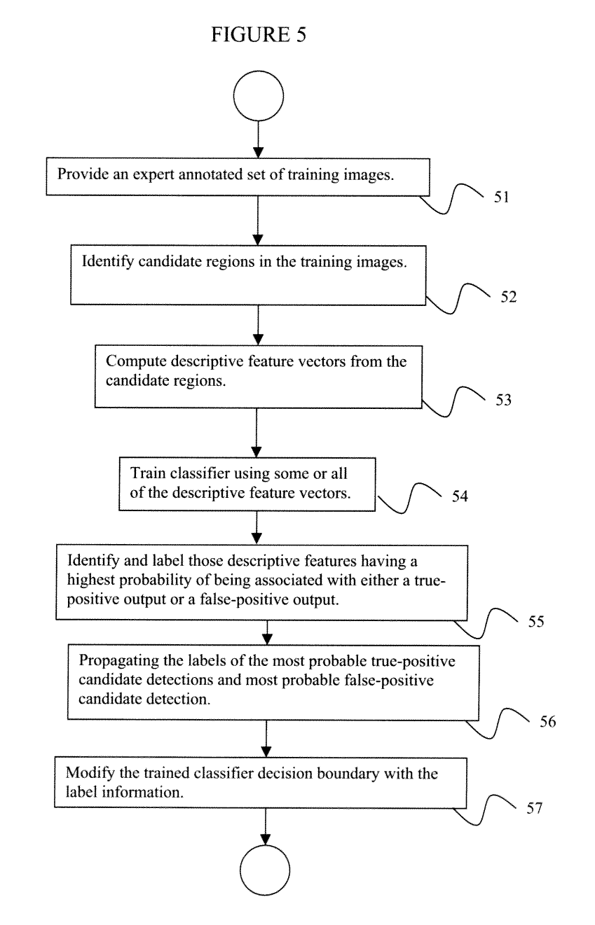

Another approach according to an embodiment of the invention is to perform a semi-supervised testing, that is, to label the most trusted points, those having the highest probability of belonging to the true- or false-positive class output by the classifier, and letting them propagate to other candidates similar to an adjacency graph approach. A classifier will typically return a real number for each candidate, and a threshold is determined to say if this candidate should belong to a positive or negative class. This real number can be used to determine the trusted points, as a higher classification value implies a more trusted the point. For this approach, a clustering step is not needed. FIG. 5 is a flowchart of a semi-supervised method for joint classification, according to an embodiment of the invention. Such an algorithm starts by providing at step 51 an expert annotated set of training images, identifying candidate regions at step 52, computing descriptive feature vectors at step 53, and, at step 54, training a classifier using all the training cases, ignoring clustering effects within each case. At step 55, those points having the highest probability of belonging to the true- or false-positive class output by the classifier are labeled, and then these labels are propagated to other candidates adjacent to the candidates with highest probability in the feature space F2 in step 56. In a semi-supervised testing according to an embodiment of the invention, an adjacency graph is built using the classification values of the testing candidates, and a similarity is calculated based on the feature vectors of every two candidates. Clustering is implicit in this approach. After this graph is built, one can let the values of the vertices of the graph propagate to other vertices, similar to other semi-supervised learning approaches. Eventually the values of the vertices will become stable, and these values can be used to make the final classification. These values can be transferred to a probability value for prediction. The above approach is just one way to do this. Another approach according to an embodiment of the invention is to also include the training feature vectors in this graph building process, and use their labels (+1: true positive/−1: false positives) as the starting point of the graph propagation. The final stable status of the graph can be used to classify the testing candidates. At step 57, the trained classifier decision is modified with the propagated label information.

Another approach according to an embodiment of the invention is to consider the clustering of the candidates before training the classifier. In this approach, one would first cluster the candidates after the candidate generation step, using any clustering algorithm as is known in the art. If there are manually labeled candidate classes, this information can be used as well in the clustering approach. This is sometimes called semi-supervised clustering or constrained clustering. Descriptive feature vectors are derived for the clusters. These features could be a weighted average of the individual candidate feature vectors, or some information about the cluster, such as a mean and standard deviation of each cluster, etc., depending on the algorithm used for the classifier training. Next, a classifier is trained using the cluster feature vectors that can take into account the clustering information in training. Finally, test cases are classified using the trained classifier. Here one can also cluster the test candidates to obtain clusters, which would help the classifier. In the classifier training, it can be assumed that candidates from one cluster would have a unique label in the classification. In this way a classifier can be trained at the cluster level, which has the potential to achieve better accuracy as well as better efficiency. Improved accuracy results from similar candidates being clustered together and sharing the same label, which makes sense in many CAD application. Improved efficiency results from the training instances being the clusters, so there are fewer data samples to train the classifier.

There are several alternative approaches for training the classifier according to other embodiments of the invention. One approach according to an embodiment of the invention is to build an adjacency graph using the clusters, and then training a semi-supervised classifier using the graph and the training labels on the clusters. This approach can be applied to the test cases after the test cases are clustered into clusters. Another approach according to an embodiment of the invention is to train a Support Vector Machines at the cluster level, using only the training candidates and clusters. This approach can be combined with other approaches according to embodiments of the invention presented above, which cluster candidates inside one patient.

A post processing clustering analysis technique according to an embodiment of the invention can increase specificity of a computer detection algorithm, by reducing the number of false positive detections by analyzing them together with, as clustered in the feature space F2, other, similarly looking detections that can be labeled or classified with more certainty by the primary classifier. The adaptation of the classifier is not to change the weights directly, but to change the final predictive value of each candidate by considering the clustering effect or by doing a semi-supervised testing.

It is to be understood that embodiments of the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

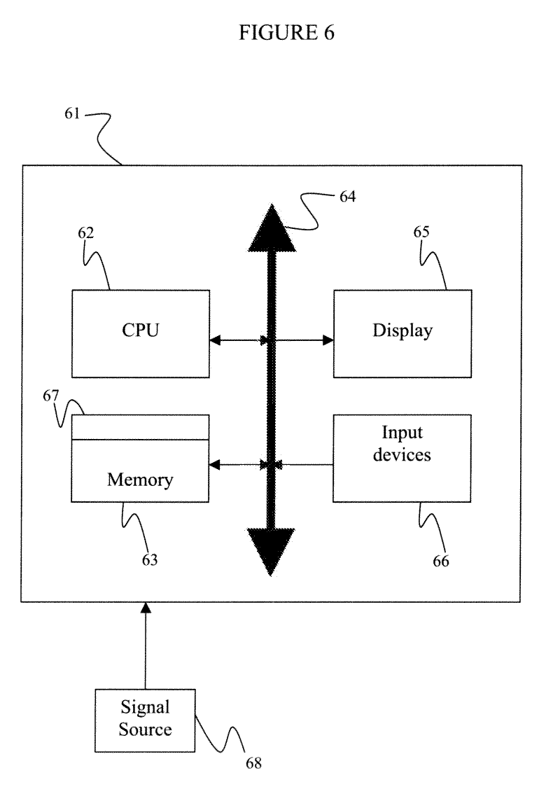

FIG. 6 is a block diagram of an exemplary computer system for implementing a a method for improving the specificity of computer aided algorithms for lesion detection, according to an embodiment of the invention. Referring now to FIG. 6, a computer system 61 for implementing the present invention can comprise, inter alia, a central processing unit (CPU) 62, a memory 63 and an input/output (I/O) interface 64. The computer system 61 is generally coupled through the I/O interface 64 to a display 65 and various input devices 66 such as a mouse and a keyboard. The support circuits can include circuits such as cache, power supplies, clock circuits, and a communication bus. The memory 63 can include random access memory (RAM), read only memory (ROM), disk drive, tape drive, etc., or a combinations thereof. The present invention can be implemented as a routine 67 that is stored in memory 63 and executed by the CPU 62 to process the signal from the signal source 68. As such, the computer system 61 is a general purpose computer system that becomes a specific purpose computer system when executing the routine 67 of the present invention.

The computer system 61 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to a preferred embodiment, those skilled in the art will appreciate that various modifications and substitutions can be made thereto without departing from the spirit and scope of the invention as set forth in the appended claims.

What is claimed is:

1. A method for training a classifier for use in a computer aided detection system comprising the steps of
providing a training set of images acquired from a plurality of patients, each said image including one or more candidate regions that have been identified as suspicious by a candidate generation step of a computer aided detection system, and wherein each said image has been manually annotated to identify lesions;
using said training set to train a classifier adapted for identifying a candidate region as a lesion or non-lesion;
clustering candidate regions having similar features for each patient individually; and
modifying said trained classifier decision boundary with an additional classification step incorporating said individual candidate region clustering.

2. The method of claim 1, wherein using said training set to train a classifier comprises deriving a set of multidimensional descriptive feature vectors from a feature computation step of a computer aided diagnosis system, wherein each candidate region is associated with a feature vector, and using the descriptive feature vectors from the training set of images to train said classifier to identify whether or not a candidate region is a lesion.

3. The method of claim 1, wherein clustering candidate regions having similar features for each patient individually comprises selecting a subset of said descriptive feature vectors suitable for clustering and applying a clustering algorithm to the subset of features to cluster the candidate regions for each patient separately.

4. The method of claim 3, further comprising assigning a label assigned to a majority of cluster members to all members of said cluster.

5. The method of claim 3, further comprising providing a providing a testing set of images acquired from a plurality of patients different from said training set, and applying said clustering algorithm to individual patient images in the testing set.

6. The method of claim 2, wherein said classifier is trained on a subset of said features in each feature vector.

7. The method of claim 1, wherein clustering candidate regions having similar features for each patient individually comprises identifying and labeling those descriptive features having a highest probability of being associated with either a true-positive output of said classifier or a false-positive output of said classifier, and propagating the labels of the most probable true-positive candidate detections and most probable false-positive candidate detection.

8. The method of claim 7, wherein said label propagation is performed using an adjacency graph approach.

9. A method for training a classifier for use in a computer aided detection system comprising the steps of:
providing a training set of images acquired from a plurality of patients, each said image including one or more candidate regions that have been identified as suspicious by a candidate generation step of a computer aided detection system, and wherein each said image has been manually annotated to identify lesions;
clustering the candidates regions into clusters, wherein each candidate region within a same cluster is associated with a same label;
training a classifier using said clusters; and
testing said classifier on a set of testing images wherein said candidate regions have been clustered.

10. The method of claim 9, wherein training a classifier using said clusters comprises building an adjacency graph using the clusters, and training a semi-supervised classifier using said adjacency graph and the training labels on the clusters.

11. The method of claim 9, wherein training a classifier using said clusters comprises training a support vector machine on the clusters.

12. A program storage device readable by a computer, tangibly embodying a program of instructions executable by the computer to perform the method steps for training a classifier for use in a computer aided detection system, the method comprising the steps of:
providing a training set of images acquired from a plurality of patients, each said image including one or more candidate regions that have been identified as suspicious by a candidate generation step of a computer aided detection system, and wherein each said image has been manually annotated to identify lesions;
using said training set to train a classifier adapted for identifying a candidate region as a lesion or non-lesion;
clustering candidate regions having similar features for each patient individually; and
modifying said trained classifier decision boundary with an additional classification step incorporating said individual candidate region clustering.

13. The computer readable program storage device of claim 12, wherein using said training set to train a classifier comprises deriving a set of multidimensional descriptive feature vectors from a feature computation step of a computer aided diagnosis system, wherein each candidate region is associated with a feature vector, and using the descriptive feature vectors from the training set of images to train said classifier to identify whether or not a candidate region is a lesion.

14. The computer readable program storage device of claim 12, wherein clustering candidate regions having similar features for each patient individually comprises selecting a subset of said descriptive feature vectors suitable for clustering and applying a clustering algorithm to the subset of features to cluster the candidate regions for each patient separately.

15. The computer readable program storage device of claim 14, the method further comprising assigning a label assigned to a majority of cluster members to all members of said cluster.

16. The computer readable program storage device of claim 14, the method further comprising providing a providing a testing set of images acquired from a plurality of patients different from said training set, and applying said clustering algorithm to individual patient images in the testing set.

17. The computer readable program storage device of claim 13, wherein said classifier is trained on a subset of said features in each feature vector.

18. The computer readable program storage device of claim 12, wherein clustering candidate regions having similar features for each patient individually comprises identifying and labeling those descriptive features having a highest probability of being associated with either a true-positive output of said classifier or a false-positive output of said classifier, and propagating the labels of the most probable true-positive candidate detections and most probable false-positive candidate detection.

19. The computer readable program storage device of claim 18, wherein said label propagation is performed using an adjacency graph approach.
